(19) United States
(12) Patent Application Publication
(10) Pub. No.: US 2018/0241041 A1
(43) Pub. Date: Aug. 23, 2018

(54) LITHIUM ION SECONDARY BATTERY

(71) Applicant: TDK CORPORATION, Tokyo (JP)

(72) Inventor: Tomohiko HASEGAWA, Tokyo (JP)

(73) Assignee: TDK CORPORATION, Tokyo (JP)

(21) Appl. No.: 15/892,499

(22) Filed: Feb. 9, 2018

(30) Foreign Application Priority Data
Feb. 17, 2017 (JP) 2017-027731

(51) Int. Cl. H01M 4/58; H01M 10/0525; H01M 10/0567; H01M 4/36; H01M 4/525

(52) U.S. Cl. CPC H01M 4/5825; H01M 10/0525; H01M 2004/028; H01M 4/364; H01M 4/525; H01M 10/0567

(57) ABSTRACT

A lithium ion secondary battery includes: a positive electrode; a negative electrode; a separator positioned between the positive electrode and the negative electrode; and an electrolyte. The positive electrode includes a lithium vanadium compound expressed by Liₐ(M)_{b}(PO₄)_{c}(where M=VO or V, and 0.9≤a≤3.3, 0.9 ≤b≤2.2, and 0.9≤e≤3.3), and the electrolyte includes an additive selected from monofluorophosphate salts and difluorophosphate salts.

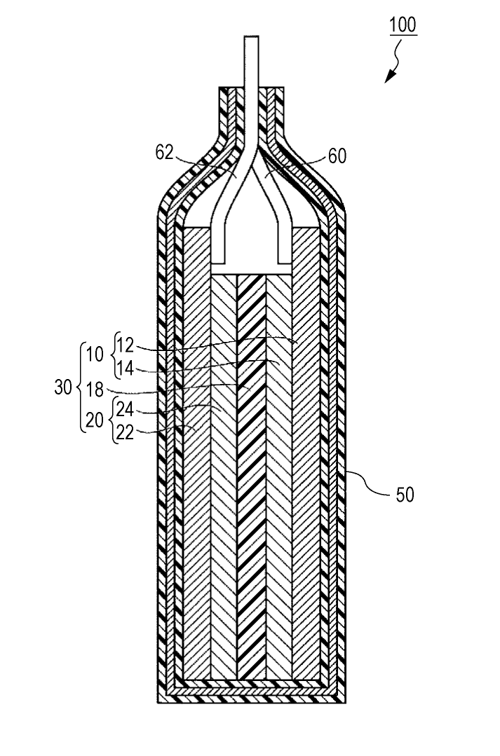

### CROSS-REFERENCE TO RELATED APPLICATION

This application claims priority from Japanese Patent Application No. 2017-027731 filed with the Japan Patent Office on Feb. 17, 2017, the entire content of which is hereby incorporated by reference.

### BACKGROUND

### 1. Technical Field

The present disclosure relates to a lithium ion secondary battery.

### 2. Description of the Related Art

In recent years, lithium ion secondary batteries have been used as a main power supply for mobile communication devices and portable electronic devices. Lithium ion secondary batteries have high electromotive force and high energy density.

Typically, as the positive electrode material (positive electrode active material) of a lithium ion secondary battery, a laminated compound of LiCoO₂ and LiNi_{1/3}Mn_{1/3}Co_{1/3}O₂ and the like, and a spinel compound of LiMn₂O₄ and the like have been used. In recent years, compounds of olivine-type structure, as represented by LiFePO₄, have gained attention. Positive electrode materials having olivine structure are known to have high thermal stability at high temperature and provide high safety.

However, a lithium ion secondary battery in which LiFePO₄ is used has a low charge/discharge voltage of approximately 3.5 V. Thus, the lithium ion secondary battery has the disadvantage of low energy density. Accordingly, LiCoPO₄, LiNiPO₄ and the like have been proposed as phosphate-based positive electrode materials with which high charge/discharge voltage can be achieved. However, even the lithium ion secondary batteries in which such positive electrode materials are used have so far been unable to provide sufficient capacity.

Among the phosphate-based positive electrode materials, vanadium phosphate compounds having the structure of LiVOPO₄ or Li₃V₂(PO₄)₃ are known as a compound with which a charge/discharge voltage on the order of 4 V can be achieved. These compounds, however, are associated with a significant generation of gas. If the compounds are applied in a battery having a metal laminate case, in particular, the shape stability of the battery is degraded.

In JP-A-2013-229303, the following has been reported: a hydrofluoric acid is added into electrolyte. Accordingly, vanadium ions, which are responsible for generation of gas, and the hydrofluoric acid react with each other, and the generation of gas is suppressed.

### SUMMARY

A lithium ion secondary battery includes: a positive electrode; a negative electrode; a separator positioned between the positive electrode and the negative electrode; and an electrolyte. The positive electrode includes a lithium vanadium compound expressed by Liₐ(M)_{b}(PO₄)_{c}(where M=VO or V, and 0.9≤a≤3.3, 0.9≤b≤2.2, and 0.9≤c≤3.3), and the electrolyte includes an additive selected from monofluorophosphate salts and difluorophosphate salts.

### BRIEF DESCRIPTION OF THE DRAWINGS

FIGURE is a schematic cross sectional view of a lithium ion secondary battery according to the present embodiment.

### DESCRIPTION OF THE EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The methods according to typical techniques have been unable to satisfy various characteristics. In particular, it has been desired to suppress the generation of gas in a laminate battery as a result of repeated cycles.

An object of the present disclosure is to provide a lithium ion secondary battery in which generation of gas as a result of repeated cycles can be suppressed.

A lithium ion secondary battery according to one aspect of the present disclosure (the present secondary battery) includes: a positive electrode; a negative electrode; a separator positioned between the positive electrode and the negative electrode; and an electrolyte. The positive electrode includes a lithium vanadium compound expressed by Liₐ(M)_{b}(PO₄)_{c}(where M=VO or V, and 0.9≤a≤3.3, 0.9≤b≤2.2, and 0.9≤c≤3.3), and the electrolyte includes an additive selected from monofluorophosphate salts and difluorophosphate salts.

In the present secondary battery, because the additive forms a satisfactory coating film on the positive electrode, dissolution of electrolyte on the positive electrode is suppressed. In addition, the monofluorophosphate anion or difluorophosphate anion in the additive traps vanadium ions eluted from the positive electrode. Accordingly, generation of gas as a result of repeated cycles can be suppressed.

Preferably, in the present secondary battery, the additive in the electrolyte has a content in a range of from 1×10⁻³ to 3×10⁻¹ mol/L.

The range is a preferable range of the added amount of additive. Accordingly, the generation of gas as a result of repeated cycles can be further suppressed.

Preferably, in the present secondary battery, the additive is difluorophosphate lithium.

Difluorophosphate lithium is more preferable as the additive. Use of difluorophosphate lithium as the additive makes it possible to further suppress the generation of gas as a result of repeated cycles.

Preferably, in the present secondary battery, the lithium vanadium compound is LiVOPO₄.

The present secondary battery makes it possible to suppress the generation of gas as a result of repeated cycles.

In the following, a preferred embodiment of the present disclosure will be described with reference to the drawing figures. However, the technology of the present disclosure is not limited to the following embodiment. The constituent elements described below may include elements that may easily occur to a person skilled in the art, and elements that are substantially identical to the disclosed constituent elements. The constituent elements described below may be combined as appropriate.

### Lithium Ion Secondary Battery.

As illustrated in the FIGURE, a lithium ion secondary battery 100 according to the present embodiment includes a stacked body 30, an electrolytic solution containing lithium ions, a case 50 in which the above elements are contained in sealed state, a lead 62, and a lead 60. The stacked body 30 includes a plate-shaped negative electrode 20 and a plate-shaped positive electrode 10 facing each other, and a plate-shaped separator 18 disposed adjacent to and between the negative electrode 20 and the positive electrode 10. One end of the lead 62 is electrically connected to the negative electrode 20. The other end of the lead 62 protrudes out of the case. One end of the lead 60 is electrically connected to the positive electrode 10. The other end of the lead 60 protrudes out of the case.

The positive electrode 10 includes a positive electrode current collector 12, and a positive electrode active material layer 14 formed on the positive electrode current collector 12. The negative electrode 20 includes a negative electrode current collector 22, and a negative electrode active material layer 24 formed on the negative electrode current collector 22. The separator 18 is positioned between the negative electrode active material layer 24 and the positive electrode active material layer 14.

### Positive Electrode

In the present embodiment, the positive electrode includes a lithium vanadium compound expressed by Liₐ(M)_{b}(PO₄)_{c}(where M=VO or V, and 0.9≤a≤3.3, 0.9≤b≤2.2, and 0.9≤e≤3.3).

### Positive Electrode Current Collector

The positive electrode current collector 12 may be formed from an electrically conductive plate material. The positive electrode current collector 12 may include a metal thin plate (metal foil) of aluminum, aluminum alloy, or stainless steel and the like, for example.

### Positive Electrode Active Material Layer

The positive electrode active material layer 14 mainly includes a positive electrode active material, a positive electrode binder, and a positive electrode conductive auxiliary agent.

### Positive Electrode Active Material

In the present embodiment, the positive electrode active material includes a lithium vanadium compound expressed by Liₐ(M)_{b}(PO₄)_{c}(where M=VO or V, and 0.9≤a≤3.3, 0.9≤b≤2.2, and 0.9≤c≤3.3).

From the positive electrode active material, as cycles are repeated, vanadium ions as the cause of generation of gas are eluted. Thus, by combining the positive electrode active material and the electrolyte according to the present embodiment, the effect of suppressing generation of gas as a result of repeated cycles can be obtained.

Preferably, the positive electrode active material of the present embodiment is LiVOPO₄.

### Positive Electrode Binder

The positive electrode binder binds the positive electrode active material, and also binds the positive electrode active material layer 14 and the positive electrode current collector 12. The binder may be any binder capable of achieving the binding described above. The binder may include, for example, fluorine resins such as polyvinylidene fluoride (PVDF) and polytetrafluoroethylene (PTFE); cellulose; styrene-butadiene rubber; ethylene-propylene rubber; polyimide resin; and polyamide-imide resin. The binder may include electron-conductive electrically conductive polymers and ion-conductive electrically conductive polymers. Examples of the electron-conductive electrically conductive polymers include polyacetylene, polythiophene, and polyaniline. Examples of the ion-conductive electrically conductive polymers include polyether-based polymer compounds, such as polyethylene oxide or polypropylene oxide, compounded with a lithium salt such as LiClO₄, LiBF₄, or LiPF₆.

The content of the binder in the positive electrode active material layer 14 is not particularly limited. When the binder is added into the positive electrode active material layer 14, the content of the binder in the positive electrode active material layer 14 is preferably 0.5 to 5 parts by mass with respect to the mass of the positive electrode active material.

### Positive Electrode Conductive Auxiliary Agent

The positive electrode conductive auxiliary agent is not particularly limited, and known conductive auxiliary agents may be used as long as the electrical conductivity of the positive electrode active material layer 14 can be improved. Examples of the positive electrode conductive auxiliary agent include carbon-based materials such as graphite and carbon black; metal fine powder of copper, nickel, stainless steel, iron and the like; and electrically conductive oxides such as ITO.

### Negative Electrode

### Negative Electrode Current Collector

The negative electrode current collector 22 may include an electrically conductive plate material. For example, as the negative electrode current collector 22, a metal thin plate (metal foil) of copper may be used.

### Negative Electrode Active Material Layer

The negative electrode active material layer 24 mainly includes a negative electrode active material, a negative electrode binder, and a negative electrode conductive auxiliary agent.

### Negative Electrode Active Material

The negative electrode active material is not particularly limited and a known electrode active material may be used as long as the material is capable of reversibly causing occlusion and release of lithium ions or deintercalation and intercalation of lithium ions. Examples of the negative electrode active material include carbon-based materials such as graphite and hard carbon; silicon-based materials such as silicon oxide (SiOₓ) and metallic silicon (Si); metallic oxides such as lithium titanate (LTO); and metallic materials such as lithium, tin, and zinc.

When a metallic material is not used as the negative electrode active material, the negative electrode active material layer 24 may further include a negative electrode binder and a negative electrode conductive auxiliary agent.

### Negative Electrode Binder

The negative electrode binder is not particularly limited. As the negative electrode binder, an electrode binder similar to the above-described positive electrode binder may be used.

### Negative Electrode Conductive Auxiliary Agent

The negative electrode conductive auxiliary agent is not particularly limited. As the negative electrode conductive auxiliary agent, a conductive auxiliary agent similar to the above-described positive electrode conductive auxiliary agent may be used.

### Electrolyte

In the present embodiment, the electrolyte includes an additive selected from monofluorophosphate salts and difluorophosphate salts.

In this way, because the additive forms a satisfactory coating film on the positive electrode, dissolution of electrolyte on the positive electrode is suppressed. In addition, the monofluorophosphate anion or difluorophosphate anion in the additive traps the vanadium ions elated from the positive electrode. Accordingly, the generation of gas as a result of repeated cycles can be suppressed.

Preferably, the additive in the electrolyte according to the present embodiment has a content in a range of from 1×10⁻³ to 3×10⁻¹ mol/L.

The range is a preferable range of the added amount of additive. Accordingly, the generation of gas as a result of repeated cycles can be further suppressed.

Preferably, in the electrolyte according to the present embodiment, the additive is difluorophosphate lithium.

Difluorophosphate lithium is more preferable as the additive. Use of difluorophosphate lithium as the additive makes it possible to further suppress the generation of gas as a result of repeated cycles.

### Solvent

The electrolyte solvent may be a solvent generally used in a lithium ion secondary battery and is not particularly limited. The electrolyte solvent may include the following solvents mixed at any desired ratio: an annular carbonate compound such as ethylene carbonate (EC) and propylene carbonate (PC); a chain carbonate compound such as diethyl carbonate (DEC) and ethyl methyl carbonate (EMC); an annular ester compound such as γ-butyrolactone; and a chain ester compound such as propyl propionate, ethyl propionate, and ethyl acetate.

### Electrolyte

The electrolyte may be a lithium salt used as the electrolyte for lithium ion secondary batteries and is not particularly limited. Examples of the electrolyte include inorganic acid anion salts such as LiPF₆, LiBF₄, and lithium bis(oxalato)borate; and organic acid anion salts such as LiCF₃SO₃, (CF₃SO₂)₂NLi, and (FSO₂)₂NLi.

A preferred embodiment of the present disclosure has been described; however, the technology of the present disclosure is not limited to the embodiment.

### EXAMPLES

In the following, the technology of the present disclosure will be described more concretely with reference to examples and comparative examples. The technology of the present disclosure, however, is not limited to the following examples.

### Example 1

### Fabrication of Positive Electrode

A slurry for forming the positive electrode active material layer was prepared by dispersing 70 parts by mass of Li(Ni_{0.85}Co_{0.10}Al_{0.05})O₂15 parts by mass of LiVOPO₄ as a lithium vanadium compound, 5 parts by mass of carbon black, and 10 parts by mass of PVDF in N-methyl-2-pyrrolidone (NMP). The slurry was applied to a surface of an aluminum metal foil with a thickness of 20 μm in such a way that the applied amount of the positive electrode active material was 9.0 mg/cm². The aluminum metal foil with the slurry applied thereon was dried at 100° C. In this way, the positive electrode active material layer was formed. Thereafter, the positive electrode active material layer was pressed and molded using a roller press, whereby the positive electrode was fabricated.

### Fabrication of Negative Electrode

A slurry for forming the negative electrode active material layer was prepared by dispersing 90 parts by mass of natural graphite, 5 parts by mass of carbon black, and 5 parts by mass of PVDF in N-methyl-2-pyrrolidone (NMP). The slurry was applied to a surface of a copper foil with a thickness of 20 μm in such a way that the coated amount of the negative electrode active material was 6.0 mg/cm². The copper foil with the slurry applied thereon was dried at 100° C. In this way, the negative electrode active material layer was formed. Thereafter, the negative electrode active material layer was pressed and molded using a roller press, whereby the negative electrode was fabricated.

### Fabrication of Electrolyte

EC and DEC were mixed to a volume ratio of EC/DEC=3/7. Into the mixture of EC and DEC, LiPF₆ was dissolved such that the concentration of LiPF₆ was 1 mol/L. Thereafter, into the resultant solution, difluorophosphate lithium (LiPO₂F₂) was added as the additive in such a way that the concentration of LIPO₂F₂ was 1.0×10⁻² mol/L. In this way, the electrolyte was fabricated.

### Fabrication of Lithium Ion Secondary Battery for Evaluation

The positive electrode and the negative electrode fabricated as described above were laid on each other with a separator of polyethylene microporous film interposed therebetween, and put in an aluminum laminate pack. Into the aluminum laminate pack, the electrolyte fabricated as described above was injected. Thereafter, the aluminum laminate pack was vacuum-sealed, whereby the lithium ion secondary battery for evaluation was fabricated.

### Measurement of Amount of Generated Gas After 500 Cycles

The lithium ion secondary battery for evaluation fabricated as described above was charged by constant current charging at a charge rate of 1.0 C until the battery voltage became 4.2 V, using a secondary battery charge/discharge testing device (manufactured by Hokuto Denko Corp.). Thereafter, the battery was discharged by constant current discharging at a discharge rate of 1.0 C until the battery voltage became 2.8 V. The current value at the charge rate (discharge rate) of 1.0 C means a current value such that the charging (discharging) ends in one hour when constant current charging (constant current discharging) is performed at 25° C. At the end of the charging/discharging, the aluminum laminate pack of the battery was partly cut to release gas from the aluminum laminate pack. Thereafter, the aluminum laminate pack was again vacuum-sealed. The volume of the battery was measured by the Archimedes method to determine a battery volume V₁ before a cycle test.

The battery whose battery volume V₁ was determined was again charged by constant current charging at the charge rate of 1.0 C until the battery voltage became 4.2 V, using the secondary battery charge/discharge testing device. Thereafter, the battery was discharged by constant current discharging at the discharge rate of 1.0 C until the battery voltage became 2.8 V. The charging and discharging was counted as one cycle, and 500 cycles of charge/discharge were performed. Thereafter, the battery volume was again measured by the Archimedes method, and a battery volume V₂ after 500 cycles was determined.

From the volumes V₁ and V₂ determined as described above, the amount of generated gas V after 500 cycles was determined according to expression (3). The results are shown in Table 1.

V=V₂−V₁ (3)

### Examples 2 to 5

The lithium ion secondary batteries for evaluation in examples 2 to 5 were fabricated in the same way as in example 1, with the exception that the amount of the additive used during the fabrication of the electrolyte was changed as shown in Table 1.

### Examples 6 to 10

The lithium ion secondary batteries for evaluation in examples 6 to 10 were fabricated in the same way as in example 1, with the exception that the additive used and the added amount thereof during the fabrication of the electrolyte were changed as shown in Table 1, wherein Li₂PO₃F is lithium monofluorophosphate.

### Examples 11 and 12

The lithium ion secondary batteries for evaluation in examples 11 and 12 were fabricated in the same way as in example 1, with the exception that the lithium vanadium compound used during the fabrication of the positive electrode was changed as shown in Table 1.

### Comparative Example 1

As shown in Table 1, the lithium ion secondary battery for evaluation in comparative example 1 was fabricated in the same way as in example 1, with the exception that no additive was added during the fabrication of the electrolyte.

The lithium ion secondary batteries for evaluation in examples 2 to 12 and comparative example 1 were measured for the amount of generated gas after500 cycles, as in example 1. The measurement results are shown in Table 1.

In examples 1 to 12, compared with comparative example 1, in which no additive was added, the amount of generated gas after 500 cycles was reduced. In addition, from the results of examples 4 and 5, it was confirmed that by optimizing the amount of the additive, the amount of generated gas after 500 cycles can be reduced even more. In addition, from the results of examples 6 to 10, it was confirmed that by using LiPO₂F₂ as the additive, the amount of generated gas after 500 cycles can be reduced even more.

From the results of examples 11 and 12, it was confirmed that when LiVOPO₄ is used as the lithium vanadium compound, the amount of generated gas after 500 cycles can be reduced even more.

TABLE 1

| | Lithium vanadium | | Added | |
|---|---|---|---|---|
| | compound | Additive | amount [mol/L] | V [mL] |
| Example 1 | LiVOPO₄ | LiPO₂F₂ | 1.0 × 10⁻² | 0.33 |
| Example 2 | LiVOPO₄ | LiPO₂F₂ | 1.0 × 10⁻³ | 0.32 |
| Example 3 | LiVOPO₄ | LiPO₂F₂ | 3.0 × 10⁻¹ | 0.35 |
| Example 4 | LiVOPO₄ | LiPO₂F₂ | 3.1 × 10⁻¹ | 0.76 |
| Example 5 | LiVOPO₄ | LiPO₂F₂ | 4.0 × 10⁻¹ | 0.77 |
| Example 6 | LiVOPO₄ | Li₂PO₃F | 1.0 × 10⁻² | 0.42 |
| Example 7 | LiVOPO₄ | Li₂PO₃F | 1.0 × 10⁻³ | 0.41 |
| Example 8 | LiVOPO₄ | Li₂PO₃F | 3.0 × 10⁻¹ | 0.45 |
| Example 9 | LiVOPO₄ | Li₂PO₃F | 3.1 × 10⁻¹ | 0.89 |
| Example 10 | LiVOPO₄ | Li₂PO₃F | 4.0 × 10⁻¹ | 0.86 |
| Example 11 | LiVPO₄ | LiPO₂F₂ | 1.0 × 10⁻² | 0.49 |
| Example 12 | Li₃V₂(PO4)₃ | LiPO₂F₂ | 1.0 × 10⁻² | 0.49 |
| Comparative | LiVOPO₄ | — | — | 1.25 |
| Example 1 | | | | |

As described above, the technology of the present disclosure provides a lithium ion secondary battery in which the generation of gas as a result of repeated cycles can be suppressed.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A lithium ion secondary battery comprising:
a positive electrode;
a negative electrode;
a separator positioned between the positive electrode and the negative electrode; and
an electrolyte, wherein
the positive electrode includes a lithium vanadium compound expressed by Liₐ(M)_{b}(PO₄), (where M=VO or V, and 0.9≤a≤3.3, 0.9≤b≤2.2, and 0.9≤c≤3.3), and
the electrolyte includes an additive selected from monofluorophosphate salts and difluorophosphate salts.

2. The lithium ion secondary battery according to claim 1, wherein the additive in the electrolyte has a content in a range of from 1×10⁻³ to 3×10⁻¹ mol/L.

3. The lithium ion secondary battery according to claim 1, wherein the additive is difluorophosphate lithium.

4. The lithium ion secondary battery according to claim 2, wherein the additive is difluorophosphate lithium.

5. The lithium ion secondary battery according to claim 1, wherein the lithium vanadium compound is LiVOPO₄.

6. The lithium ion secondary battery according to claim 2, wherein the lithium vanadium compound is LiVOPO₄.

7. The lithium ion secondary battery according to claim 3, wherein the lithium vanadium compound is LiVOPO₄.

8. The lithium ion secondary battery according to claim 4, wherein the lithium vanadium compound is LiVOPO₄.
